(19) United States
(12) Patent Application Publication
(10) Pub. No.: US 2006/0271650 A1
(43) Pub. Date: Nov. 30, 2006

(54) Framework for establishing application system

(75) Inventors: Hirotomo Kobayashi, Tokyo (JP); Masayuki Hagiwara, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/432,321

(22) Filed: May 12, 2006

(30) Foreign Application Priority Data
May 13, 2005 (JP) 2005-141722

(51) Int. Cl. G06F 15/177

(52) U.S. Cl. 709/220

(57) ABSTRACT

A framework for establishing an application system, the framework including: a plurality of data processing modules that is provided with an interface in common with one another, and performs data processing; and a manager module that communicates with the data processing modules via the interface, and controls data transfer between the data processing modules and the data processing performed by each of the data processing modules.

### RELATED APPLICATION(S)

The present disclosure relates to the subject matter contained in Japanese Patent Application No. 2005-141722 filed on May 13, 2005, which is incorporated herein by reference in its entirety.

### FIELD

The present invention relates to a framework for establishing an application system and a semiconductor device capable of controlling processes of a plurality of modules to realize a desired function.

### BACKGROUND

In embedded devices such as a playback device, a recording device, or an image display device, an application system for processing a wide variety of information such as image data or audio data are established by combining a plurality of software or hardware modules. The modules (hereinafter referred to as IP module) have interfaces such as an application programming interface (API) for allowing access to the respective processes performed by each of the modules. However, the interfaces of the IP modules are not provided in common with one another between the modules. Therefore, in order to establish an application system with a combination of a plurality of IP modules, it is required to prepare the settings for accessing the interfaces in accordance with respective IP modules. And, the desired system function is realized by controlling the IP modules connected to each other with the respective interfaces (for conventional example, see JP-A-2004-259033). A platform for establishing an application system by combining a plurality of IP modules for obtaining a desired system function is denoted as “a framework for establishing an application system” in the description herein. The implementation of the system function with the framework for establishing an application system is usually carried out by use of software program.

In order to modify the system function in the application system, or to implement another system function, recombination of the IP modules is performed. Note here that “recombination of IP modules” includes “replacement of IP modules”, “alteration of processes of IP modules”, “addition of IP modules”, “deletion of IP modules”, “replacement of hardware configuring IP modules with software program.” When recombination of IP modules is performed, connection of the interfaces of the added or changed IP modules is newly performed. Since the operation as the system function is influenced by the connection of the new interfaces, it becomes necessary to verify the system function for a considerable time.

Further, when a problem arises in the system function, it is difficult to specify which of the IP module itself or the interface connecting the IP modules caused the problem in the system function. Therefore, manpower required for developing the application system increases in accordance with the number of IP modules. Further, the operation of each IP module depends on the operations of other IP modules and the interfaces with other IP modules. In other words, modification in one of the IP modules might influence the operations of other IP modules with extremely high probability. Accordingly, the IP module cannot independently be developed without considering relationships with other IP modules, and, it becomes difficult to guarantee proper operation of the independently developed IP module in the system operation. Further more, the reuse of the IP module becomes difficult because of the dependency relation with other IP modules and interfaces with other IP modules.

### SUMMARY

The present invention is directed a framework for establishing an application system and a semiconductor device capable of reducing time required for recombination of modules for implementing a desired function.

According to a first aspect of the invention, there is provided a framework for establishing an application system, the framework including: a plurality of data processing modules that is provided with an interface in common with one another, and performs data processing; and a manager module that communicates with the data processing modules via the interface, and controls data transfer between the data processing modules and the data processing performed by each of the data processing modules.

### BRIEF DESCRIPTION OF THE DRAWINGS

In the accompanying drawings:

FIG. 1 is a schematic diagram showing a configuration of a framework for establishing an application system according to a first embodiment;

FIG. 2 is a schematic diagram showing a configuration of an IP module according to the first embodiment;

FIG. 3 is a chart showing an example of configuration information according to the first embodiment;

FIG. 4 is a schematic diagram showing a configuration of a manager module according to the first embodiment;

FIGS. 5A and 5B are schematic diagram showing examples of a sequence pattern, wherein FIG. 5A shows an example of the sequence pattern with four IP module areas, and FIG. 5B shows an example where the sequence pattern branches;

FIG. 6 is a schematic diagram showing an example of IP module control by the manager module according to the first embodiment;

FIG. 7 is a schematic diagram showing a first configuration example of the IP module according to the first embodiment;

FIG. 8 is a schematic diagram showing a second configuration example of the IP module according to the first embodiment;

FIG. 9 is a schematic diagram showing a third configuration example of the IP module according to the first embodiment;

FIG. 10 is a schematic diagram showing a fourth configuration example of the IP module according to the first embodiment;

FIG. 11 is a flowchart for explaining a method for establishing the application system with the framework;

FIG. 12 is a schematic diagram for explaining the condition of connecting the IP module to the manager module by the framework for establishing the application system according to the first embodiment;

FIG. 13 is a schematic diagram for explaining IP module control by the framework for establishing the application system according to the first embodiment;

FIG. 14 is a schematic diagram for explaining deletion of the IP module from the manager module by the framework;

FIG. 15 is a schematic diagram showing an example of implementing the system function by the framework;

FIG. 16 is a schematic diagram showing an example of the framework for establishing the application system shown in FIG. 15 added with an interface having a callback function;

FIG. 17 is a schematic diagram showing another example of implementing the system function by the framework for establishing the application system according to the first embodiment;

FIG. 18 is a schematic diagram showing an example of the framework for establishing the application system shown in FIG. 17 added with an interface having a callback function;

FIG. 19 is a schematic diagram for explaining an example of reusing the IP module by the framework for establishing the application system according to the first embodiment;

FIG. 20 is a schematic diagram for explaining an example of changing the core IP of the IP module by the framework for establishing the application system according to the first embodiment;

FIG. 21 is a schematic diagram for explaining an example of replacing the IP module by the framework for establishing the application system according to the first embodiment;

FIG. 22 is a schematic diagram showing a configuration of a framework for establishing an application system according to a second embodiment;

FIG. 23 is a schematic diagram showing an example of forming the framework for establishing the application system according to the second embodiment with a host system LSI and a companion chip;

FIG. 24 is a schematic diagram showing an example of implementing the framework for establishing the application system according to the second embodiment on a plurality of platforms;

FIG. 25 is a schematic diagram showing a configuration of an IP module unit according to the third embodiment;

FIGS. 26A and 26B are schematic diagrams showing configurations of the hardware IP unit of the IP module unit shown in FIG. 25, wherein FIG. 26A shows an example of executing the process of the core IP with software, and FIG. 26B shows an example of executing the process of the core IP with hardware;

FIG. 27 is a schematic diagram showing a configuration of the CIF unit of the IP module unit shown in FIG. 25;

FIG. 28 is a schematic diagram showing a configuration of a manager module unit according to the third embodiment;

FIG. 29 is a schematic diagram showing a configuration of the configuration IP unit of the manager module unit shown in FIG. 28;

FIGS. 30A and 30B are schematic diagrams showing a configuration of the media controller unit of the manager module unit shown in FIG. 28, wherein FIG. 30A shows an example of operating the logic with software, and FIG. 30B shows an example of operating the logic with hardware;

FIG. 31 is a schematic diagram showing a configuration of the semiconductor device according to the third embodiment;

FIG. 32 is a schematic diagram showing a configuration example of the semiconductor device according to the third embodiment;

FIG. 33 is a schematic diagram showing an example of making the semiconductor device shown in FIG. 32 hardware as the companion chip; and

FIG. 34 is a schematic diagram showing an exemplary configuration of the semiconductor device shown in FIG. 32 a single chip as an LSI.

### DETAILED DESCRIPTION OF THE EMBODIMENTS

Referring now to the accompanying drawings, there are shown embodiments of the invention. In the following description, parts common among embodiments or examples are denoted by the same reference numerals correspondingly, and redundant description will be avoided. Respective diagrams to be referred to are schematic diagrams for explaining the invention and promoting understanding of the invention. For the sake of convenience of illustration in the drawings, there may be differences in shape, size, ratio, etc. from a real apparatus. These differences may be changed on design suitably in consideration of the following description and the known techniques.

### First Embodiment

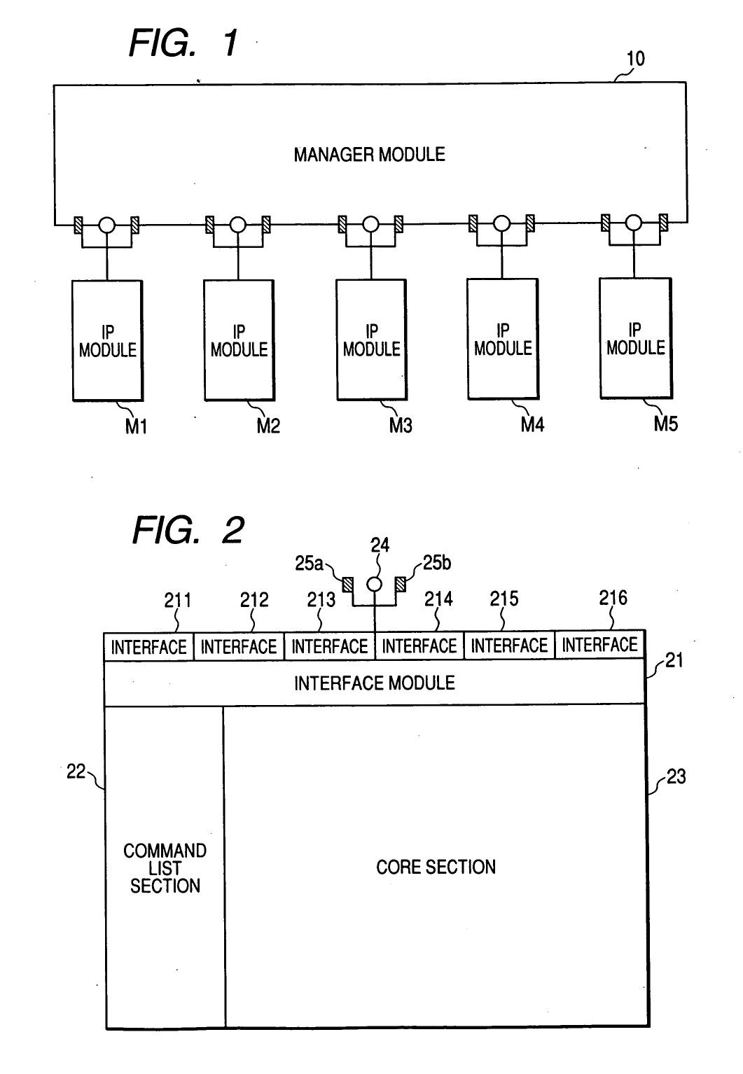

As shown in FIG. 1, a framework for establishing an application system according to the first embodiment is provided with a plurality of IP modules (data processing modules) M1-M5 respectively having interfaces with the same functions, and a manager module 10 connected to the plurality of IP modules M1-M5 via the respective interfaces and for controlling data transfer between the plurality of IP modules M1-M5, and for controlling processes in the plurality of IP modules M1-M5. Although FIG. 1 shows an example with five IP modules, M1-M5, the number of IP modules to be connected to the manager module 10 is determined in accordance with the system to be implemented with the framework for establishing an application system (hereinafter referred to simply as “framework”) shown in FIG. 1.

As shown in FIG. 2, the IP modules M1-M5 each have an interface module 21 including a plurality of interfaces 211-216, a command list section 22, and a core section 23. The interfaces 211-216 are common interfaces having the same specifications of connection among the IP modules M1-M5 shown in FIG. 1. Namely, the IP modules M1-M5 each include the interfaces 211-216. Although FIG. 2 shows an example with six interfaces, 211-216, the number of the interfaces is determined in accordance with the system function to be implemented using the IP modules M1-M5. It will hereinafter be denoted as encapsulation to configure the IP module using the interface module 21, the command list section 22, and the core section 23.

Parameters and commands (information) for controlling the respective processes of the IP modules M1-M5 are described in the command list section 22. In another word, the command list section 22 stores information (parameters and commands) that defines a behavior of the process (data processing) performed by the core section 23. The parameters to be described in the command list section 22 are configured to be set from external modules or processes. The core section 23 performs the process (data processing) by hardware or software in accordance with the information described in the command list section 22. In another word, the core section 23 performs the process (data processing) in the behavior defined by the information stored in the command list section 22. For example, the function of the IP module can be realized by hardware using a semiconductor integrated circuit (such as an LSI) including a memory storing the process content and one of a central processing unit (CPU) and a digital signal processor (DSP) for performing the process read out from the memory, and performs the data processing. The memory included in the semiconductor integrated circuit provides a work area for the data processing performed by the DSP. In a case where all of the processing functions of the core section 23 are actually preformed on the semiconductor integrated circuit having the memory and an operational device such as the CPU or the DSP, all of them need to be described with software running on the hardware environment. Further, hardware implementation of all or a part of the processing function of the core section 23 can be achieved using existing hardware design properties (IP), or newly implementing as hardware. Namely, the core section 23 includes not only the memory and a general purpose operating device such as the CPU or the DSP, but also specific hardware having all or a part of the functions of the core section 23.

Note that the manager module 10 controls the processes of the IP modules M1-M5 and the data transfer between the IP modules M1-M5 via a connecting section 24 and connecting sections 25a and 25b, respectively, for connecting the IP modules M1-M5 with the manager module 10. Specifically, the control of the processes of the IP modules M1-M5 by the manager module 10 is performed via the connecting section 24. Further, the data transfer between the IP modules M1-M5 through the manager module 10 is controlled via the connecting sections 25a and 25b.

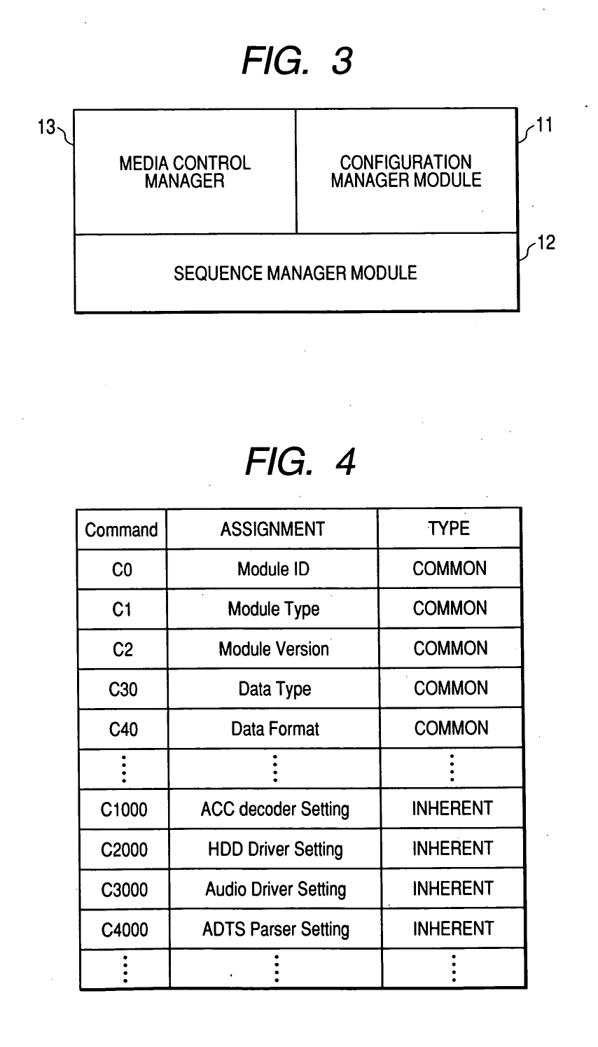

As shown in FIG. 3, the manager module 10 includes a configuration manager module 11, a sequential manager module 12, and a media control manager module 13.

The configuration manager module 11 controls information of commands for the functions processed by the IP modules M1-M5 for implementing the desired system function. In other words, the configuration manager module 11 controls the configuration information such as the command lists of all of the IP modules controlled by the manager module 10 and the parameters set in the command lists. For example, static sequence patterns, the command lists of the IP modules, information regarding connections between the IP modules are enabled or disabled, and so on are controlled.

FIG. 4 shows an example of the configuration information controlled by the configuration manager module 11. The commands indicated with “COMMON” in the “TYPE” column of FIG. 4 are the commands common to the IP modules M1-M5 shown in FIG. 1. For example, the commands “C0”, “C1”, “C2”, “C30”, and “C40” denote a module identifier (ID) of one of the IP modules M1-M5, a module type, a module version, a data type, a data format, respectively.

On the contrary, the commands indicated with “INHERENT” in the “TYPE” column of FIG. 4 are the commands inherent in the IP modules M1-M5, respectively. For example, the command “C1000” is for setting an advanced audio coding (AAC) decoder, and described in the IP module for the AAC decoder. Further, the command “C2000” is for setting a hard disk driver, the command “C3000” is for setting an audio driver, and the command “C4000” is for setting an audio data transport stream (ADTS) parser. Each of the commands controlled by the configuration manager module 11 is provided with a concrete value stored as a message of a character string or numerical string, and an exchange of the message with the IP module is performed using a dedicated API.

The sequence manager module 12 generates a sequence pattern (sequence list) defining method (execution method) for performing process including the data processing performed by the IP modules M1-M5 in order for implementing the desired system function. The IP modules M1-M5 are registered in the sequence pattern, and the execution method including information, such as an execution order of the IP modules M1-M5, is defined. Further, the sequence manager module 12 can even create the optimum sequence pattern by performing selection of the static sequence pattern or adjustment of the sequence pattern during execution in accordance with a requirement of an application to be implemented or the system function to be implemented.

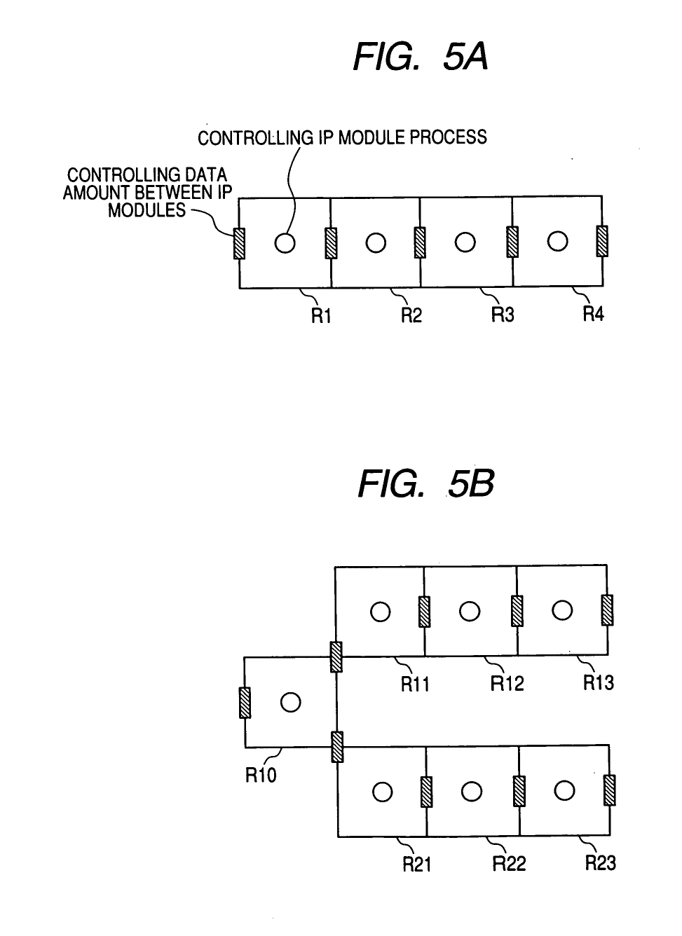

FIGS. 5A and 5B show examples of the sequence patterns. FIG. 5A shows the example in which the sequence pattern includes four IP module areas R1-R4. By registering the IP modules respectively in the IP module areas R1-R4, the desired system function can be implemented. Namely, the IP modules registered in the IP module areas R1-R4 are executed in sequence to realize the desired system function. For example, it is assumed that the IP modules M1-M4 are respectively registered in the IP module areas R1-R4. The amount of data transferred between the IP modules M1-M4 is adjusted in accordance with the condition of the amount of data which can be processed by each of the IP modules M1-M4. The control of the amount of data and the processes of the IP modules M1-M4 registered in the sequence pattern is performed by the media control manager 13 described later.

FIG. 5B shows the example in which the sequence pattern includes seven IP module areas R10-R13, and R21-R23. In the sequence pattern shown in FIG. 5B, the data flow branches after the process of the IP module registered in the IP module area R10. One of the data processing is performed by the IP modules registered in the IP module areas R11-R13. And, the other of the data processing is performed by the IP modules registered in the IP module areas R21-R23.

The control of the amount of data transferred between the IP modules registered in the IP module areas R1-R4, R10-R13, and R21-R23 and the control of the processes in the IP modules registered there are each described in the sequence pattern as a model pattern. In the FIGS. 5A and 5B, an indication with hatching denotes presence of the control of the amount of data, which is transferred between the IP modules, by the media control manager 13, and an indication with a circle denotes presence of the control of the process in each of the IP modules by the media control manager 13 (the same applies to the below).

The media control manager 13 performs control of the IP module registered in the sequence pattern created by the sequence manager module 12. Specifically, the sequence pattern created by the sequence manager module 12 is implemented in the media control manager 13, and the media control manager 13 performs initialization of the IP module registered in the sequence pattern and acquisition or setting of the property information thereof. Further, the media control manager 13 controls the processes of the IP modules and the data between the IP modules. It is hereinafter denoted as “creation of entity” for the IP module to perform initialization of the IP module and acquisition or setting of the property information. By creating the entity, an environment allowing the IP module to perform the process is set. As an example thereof, the working memory area to be used by the IP module is prepared.

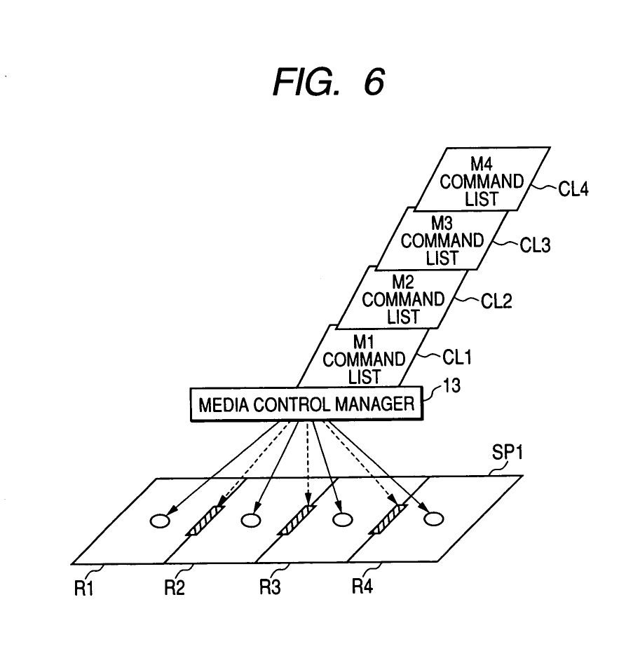

An example of establishing an application system using the framework shown in FIG. 1 will hereinafter be explained. In the following explanations, the case in which “an audio player system function for outputting music content (AAC compressed data in the ADTS format) stored in a hard disk drive (HDD) from a speaker” is built is explained as an exemplification. FIG. 6 shows control of the IP modules M1-M4 by the manager module 10. Namely, the media control manager 13 controls the IP modules M1-M4 registered in the IP module areas R1-R4 of the sequence pattern SP1 in accordance with the command lists CL1-CL4 of the IP modules M1-M4 stored in the configuration manager module 11 in FIG. 3. In the arrows shown in FIG. 6 starting from the media control manager 13 and heading for the sequence pattern SP1, the arrow with a solid line denotes the control of the processes of the IP modules M1-M4 by the media control manager 13, while the arrow with a broken line denotes the control of the data transfer between the IP modules M1-M4 (the same applies to the below). The IP modules M1-M4 are created as binary modules each encapsulating the command list defined by the framework for implementing a desired system function and the core IP having a function for processing the command list.

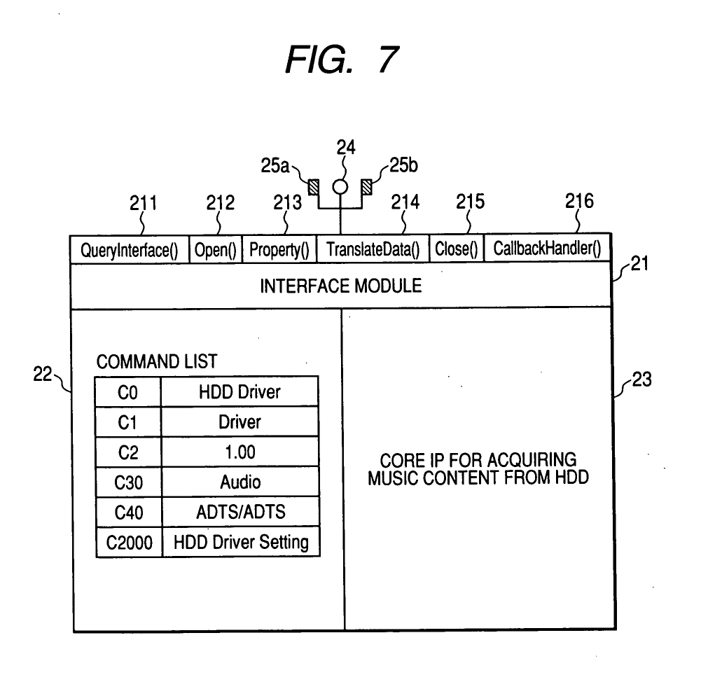

FIGS. 7-10 show configuration examples of the IP modules M1-M4, respectively. The IP module M1 shown in FIG. 7 is provided with “a core IP for acquiring music content from the HDD” in a core section 23. The commands C0 through C2000 for controlling the process of the core section 23 are stored in the command list section 22. Further, the interface module 21 includes interfaces 211-216 described below.

As shown in FIG. 7, the interface 211 is a query interface (QueryInterface( )) used for linking the core section 23 of the IP module M1 with the manager module 10. The interface 212 is an open interface (Open( )) used for creating the entity of the IP module M1. The interface 213 is a property interface (Property( )) for controlling the process in the IP module M1 with the command and a message of character string or numerical string corresponding to the command. The interface 214 is a translate interface (TranslateData( )) for controlling data transfer between the IP module M1 and other IP modules performed via the manager module 10. The interface 215 is a close interface (Close( )) used for deleting the IP module M1 registered in the sequence pattern from the framework. The interface 216 is a callback interface (CallbackHandle( )) for, in response to a callback from the IP module M1, registering the process content of the callback in the manager module 10. The process of the IP module M1 sending a request to the manager module 10 when the process, the IP module M1 tried to perform in accordance with the control of the manager module 10, is difficult to be carried out is denoted as “callback.”

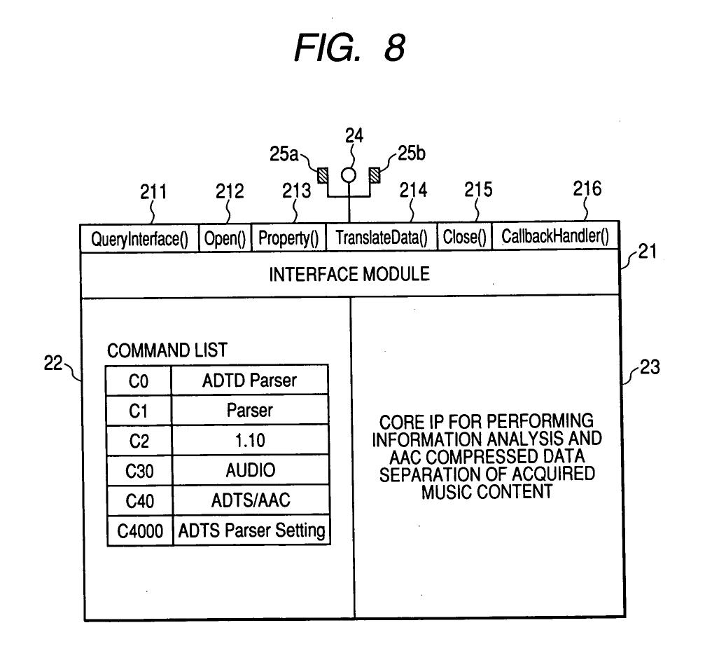

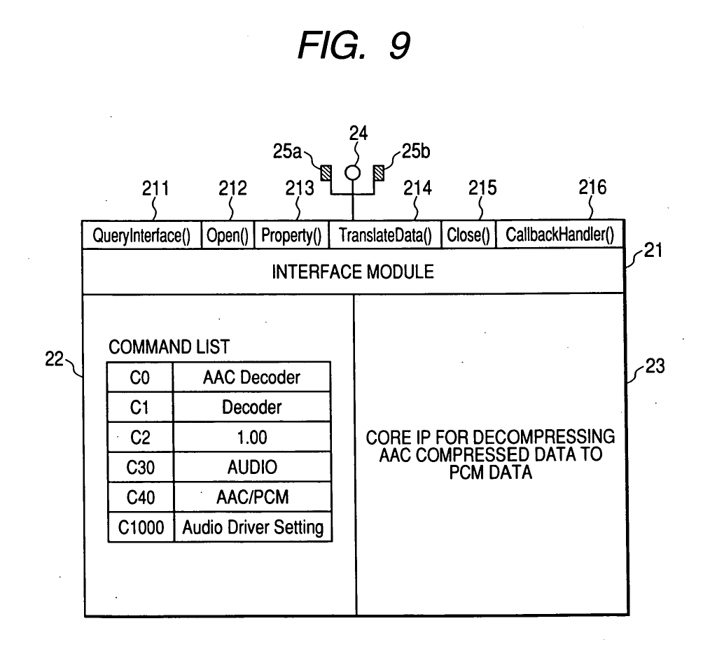

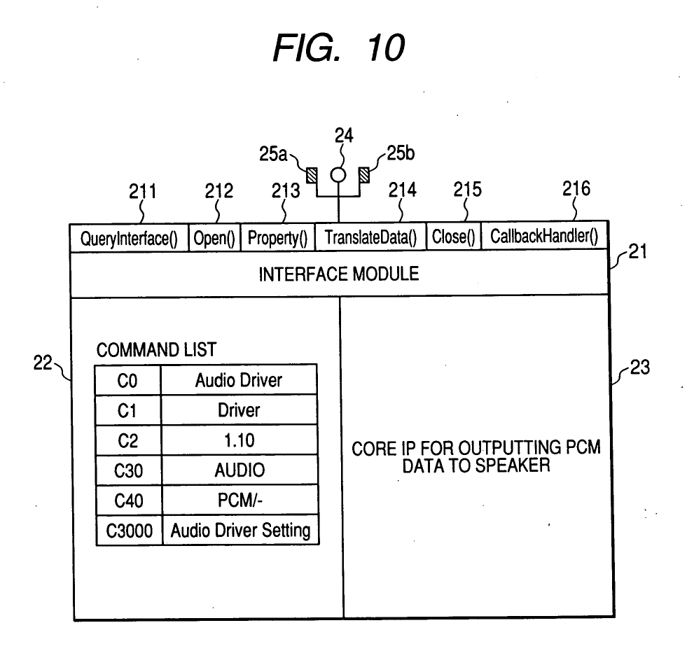

The IP module M2 shown in FIG. 8 is provided with “a core IP for performing information analysis and ACC compressed data separation of the acquired music content” in the core section 23. The commands C0 through C4000 for controlling the process of the core section 23 are stored in the command list section 22. The interface module 21 includes the common interfaces 211-216 the same as in the IP module M1. The IP module M3 shown in FIG. 9 is provided with “a core IP for decompressing the AAC compressed data to pulse code modulation (PCM) data” in a core section 23. The commands C0 through C1000 for controlling the process of the core section 23 are stored in the command list section 22. The interface module 21 includes the common interfaces 211-216 the same as in the IP module M1. The IP module M4 shown in FIG. 10 is provided with “a core IP for outputting the PCM data to the speaker” in a core section 23. The commands C0 through C3000 for controlling the process of the core section 23 are stored in the command list section 22. The interface module 21 includes the common interfaces 211-216 the same as in the IP module M1.

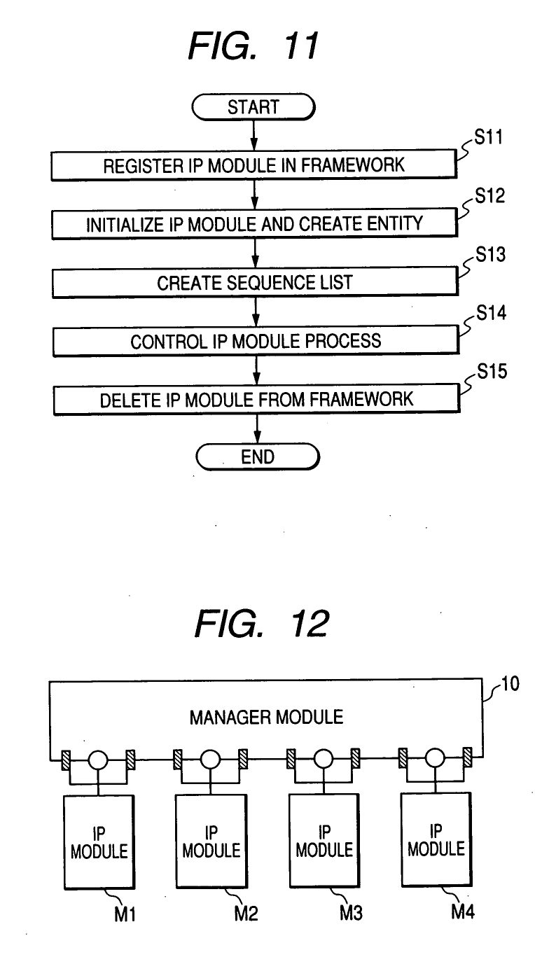

A method of establishing the application system with the framework shown in FIG. 1 will now be explained using a flowchart shown in FIG. 11. In the following, the case in which “an audio player system function for outputting music content (AAC compressed data in the ADTS format) stored in an HDD from a speaker” is built using the IP modules M1-M4 explained above is explained as an exemplification.

(A) In step S11, the IP modules M1-M4 are registered in the framework. In other words, as shown in FIG. 12, the IP modules M1-M4 are connected to the manager module 10 using the query interfaces.

(B) In step S12, the manager module 10 initializes the IP modules M1-M4 using the open interface to create the entities of the IP modules M1-M4.

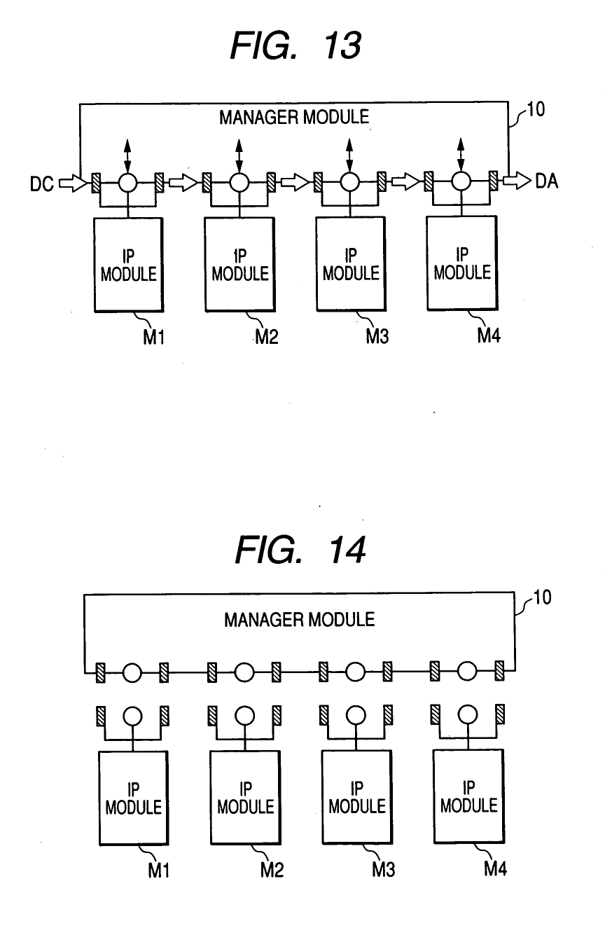

(C) In step S13, the manager module 10 creates the sequence pattern. Subsequently, in step S14, the manager module 10 controls the processes of the IP modules M1-M4 using the property interfaces and translate interfaces. In this case, as shown in FIG. 13, the control of the processes of the IP modules M1-M4 by the manager module 10 is performed via the connecting section 24. In FIG. 13, the arrows linking the connecting section 24 with the manager module 10 denote the control of the processes with the property interface. Further, the data transfer between the IP modules M1-M4 through the manager module 10 is controlled by the translate interface via the connecting sections 25a and 25b. As shown in FIG. 13, the content data DC input to the IP module M1 is processed by the IP modules M1-M4 in this order. And then, the audio data DA is output from the IP module M4. In other words, the PCM data output from the IP module M3 is output from the speaker.

(D) In step S14, the IP modules M1-M4 are deleted from the framework. Namely, as shown in FIG. 14, the manager module 10 deletes the entities of the IP modules M1-M4 from the framework utilizing the close interface. For example, it releases the memory area which has been used by the IP modules M1-M4.

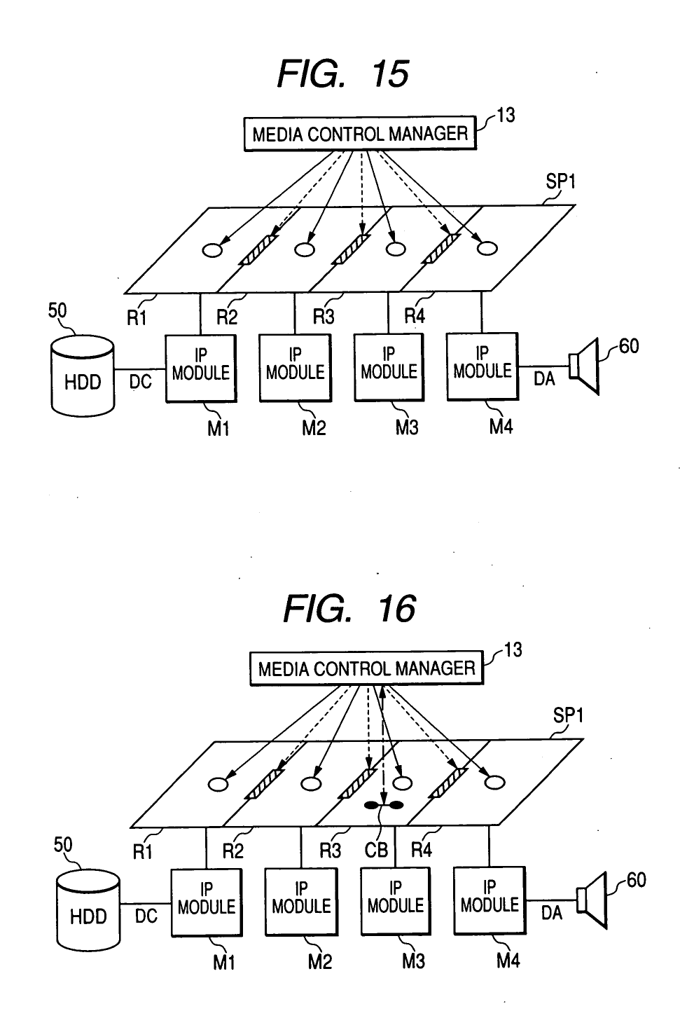

The configuration of the framework for controlling the audio player system function explained above by the media control manager 13 is shown in FIG. 15. FIG. 15 shows the configuration in which the IP modules M1-M4 is registered in the IP module areas R1-R4 of the sequence pattern SP1 and the IP modules M1-M4 are controlled by the media control manager 13. As shown in FIG. 15, the content data DC stored in an HDD 50 is processed by the IP modules M1-M4 in this order, and output to the speaker 60 as the audio data DA.

Further, when establishing the system function with the framework shown in FIG. 1, a callback function having an interface having the functions of the interfaces 213 and 214 can be added instead of the callback interface. “The callback function” is used as an interface for the IP manager to make a request to the manager module. For example, if the data to be processed by the AAC decoder in the IP module M3 is lacking, the callback function is used for requiring the media control manager 13 to perform a process for requiring the data. When using the callback function, the callback can be controlled by registering the callback function in the manager module 10 by the interface 213.

FIG. 16 shows a framework configuration in the case of using the callback function. An interface CB shown in FIG. 16 is provided with the functions of the interfaces 213 and 214 of the IP module M3 shown in FIG. 15, thereby implementing the function of the callback. The arrow of a dashed line shown in FIG. 16 linking the media control manager 13 with the sequence pattern SP1 denotes a request from the IP module M1 to the media control manager 13 (the same applies to the below).

By preparing the command lists and the sequence pattern, in a similar manner to the method of implementing the audio player system function explained above, a video player, a player for content including audio data and video data, and so on can be implemented. Further, by defining the sequence patterns, various players, viewers (image display functions), and functions combining these functions can be implemented in a similar manner to the method explained above.

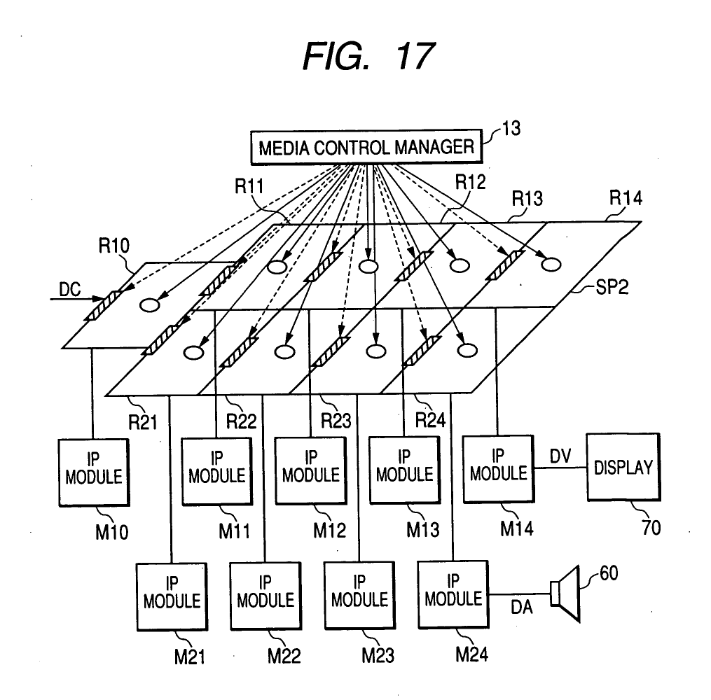

For example, FIG. 17 shows the framework configuration for implementing an MP4 player function.

The function of reproducing on the speaker the content which is made by compressing audio data in the AAC format, compressing video data in the Motion Picture Experts Group-4 (MPEG4) video format, and further multiplexing them in the MP4 format is denoted as “an MP4 player function.”

The framework shown in FIG. 17 includes a sequence pattern SP2 for implementing the MP4 player function, command lists of the IP modules M10 through M14, and M21 through M24 registered in the sequence pattern SP2, and the media control manager 13 for controlling the IP modules using the sequence pattern and the command lists.

The IP module M10 registered in the IP module area R10 of the sequence pattern SP2 shown in FIG. 17 has a function (MP4 Demuxer) of dividing the content multiplexed in the MP4 format into the audio data and the video data. Namely, the IP module M10 includes a core IP for dividing the content data DC input thereto into the audio data compressed in the AAC format and the video data compressed in the MPEG4 video format, and the command list for controlling the process of the core IP. Since the audio data and the video data thus divided are separately processed, the sequence pattern also branches into two processes.

In order for processing the video data, the IP modules MN1 through M14 are connected in this order. Namely, the IP modules MN1 through M14 are respectively registered in the IP module areas R11 through R14 shown in FIG. 17.

The IP module MN1 has a function (M4V Parser) of analyzing information necessary for decoding the video data compressed in the MPEG4 video format. The IP module M12 has a function (M4V Decoder) of decoding the video data compressed in the MPEG4 video format in accordance with the information analyzed by the IP module M11. The IP module M13 has a function (Video Renderer) of storing the video data until the decoded video data is transferred to the video driver of the IP module M14. The IP module M14 has a function (Video Driver) of displaying the decoded video data DV on a display 70.

Meanwhile, in order for processing the audio data, the IP modules M21 through M24 are connected in this order. Namely, the IP modules M21 through M24 are respectively registered in the IP module areas R21 through R24 shown in FIG. 17.

The IP module M21 has a function (ADTS Parser) of analyzing information necessary for decoding the audio data compressed in the AAC format. The IP module M22 has a function (AAC Decoder) of decoding the audio data compressed in the AAC format in accordance with the information analyzed by the IP module M21. The IP module M23 has a function (Audio Renderer) of storing the audio data until the decoded audio data is transferred to the audio driver of the IP module M24. The IP module M24 has a function (Audio Driver) of outputting the decoded audio data DA to the speaker 60. The audio data DA output from the IP module M14 is output from the speaker 60. Note that the content data DC can directly be input to the IP module M1 as a stream signal, or the IP module with a function of inputting the stream signal can be registered in the framework shown in FIG. 17 to input the content data DC to the IP module M1.

FIG. 18 shows a framework configuration in the case of using the callback function. An interface CB shown in FIG. 18 is provided with the functions of the interfaces 213 and 214 of the IP module M12 shown in FIG. 17, thereby implementing the function of the callback.

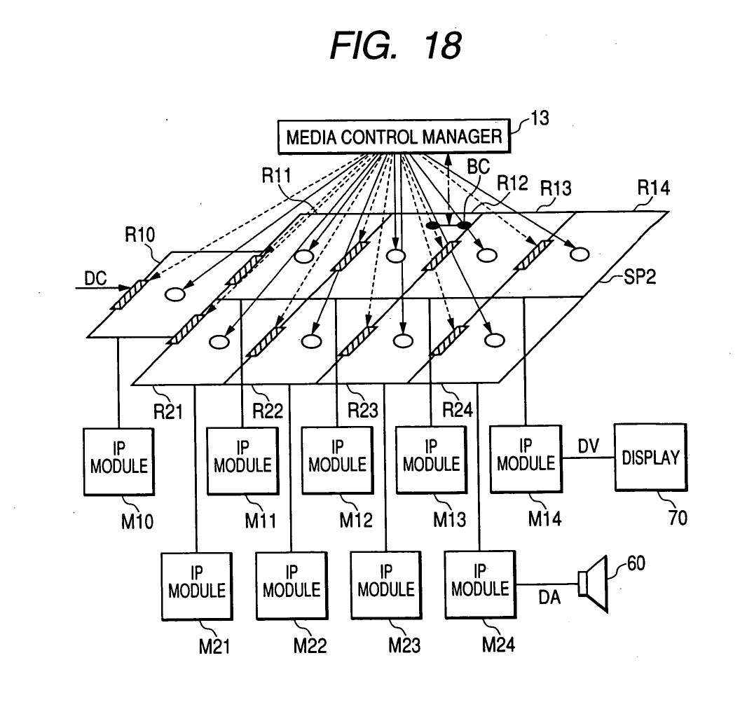

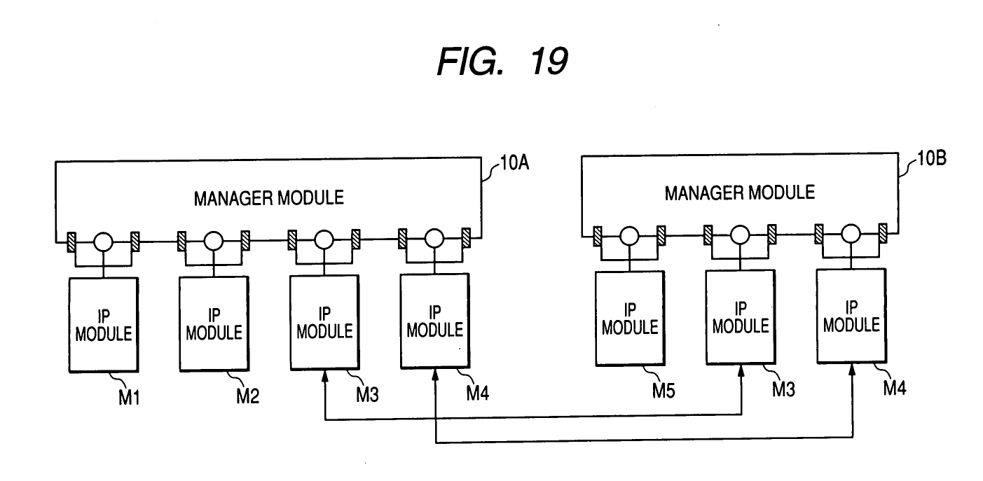

Since the framework shown in FIG. 1 is provided with unified interfaces and the class of commands, reuse of the IP modules becomes possible in a plurality of sequence patterns. For example, it is possible to register the IP modules M3 and M4 out of the IP modules M1-M4, which are registered in the manager module 10A, in the manager module 10B in which the IP module M5 is registered, as shown in FIG. 19. Namely, the IP modules M3 and M4 can be registered in the manager module 10B implementing a different system function from the manager module 10A.

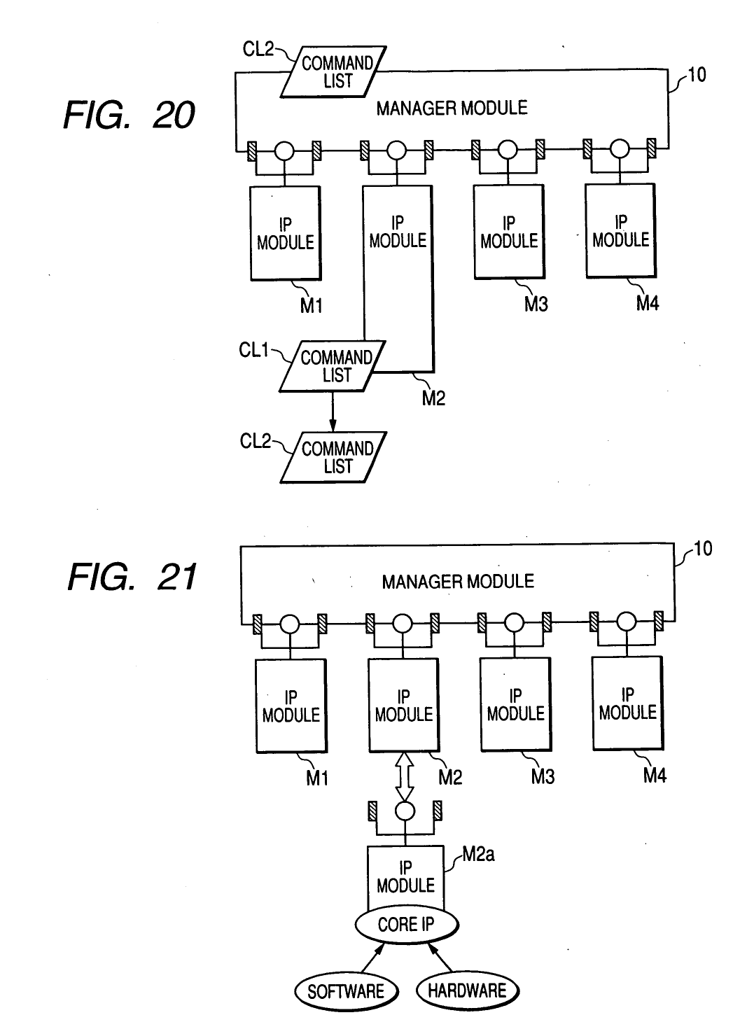

Further, the control of the process in each of the IP modules is performed by a message (information) of a character string or a numerical string based on the command list with one unified interface. Therefore, changes in the core IP function of each of the IP modules by adding or deleting the function can be dealt with only by correcting the command list. As a result, the influence to the whole application system caused by the change in the core IP of the IP module can be reduced. For example, the case in which the core IP of the IP module M2 shown in FIG. 20 is modified and the command list CL1 of the IP module M2 is changed to the command list CL2 is considered. In this case, the modification of the core IP of the IP module M2 can be dealt with by changing the command list CL1 in the command lists defined in the manager module 10, to which the IP module M2 is registered, to the command list CL2. Namely, the influence to the whole system caused by the modification of the core IP of the IP module M2 can be minimized.

Further, as already described above, the function of the core IP of the IP module can be implemented with hardware by providing registers for the commands described above. Namely, the core IP of the IP module may be configured as a software program or hardware. Therefore, even if the core IP of the IP modules have been developed by different developers or written with different algorithms, it can be replaced with another IP module registered in the framework by modularizing as the IP module. For example, as shown in FIG. 21, in the case in which the IP module M2 registered in the manager module 10 is replaced with the IP module M2a, whether the core IP of the IP module M2a is software or hardware does not influence the whole application system.

As explained above, in the framework for establishing he application system according to the first embodiment shown in FIG. 1, the system functions for handling various kinds of information such as data, images (still images of moving images), or audio can be implemented by registering the IP modules M1-M5 provided with the same interfaces in the manager module 10. Therefore, each of the IP modules M1-M5 can independently be developed without considering interfaces with other IP modules. And, by registering the IP module, which is independently developed and verified, in the framework, the verification time as the whole system can be reduced. Further, modifications or reuse of the IP module is easy. Namely, in the framework shown in FIG. 1, the time required for recombining the IP modules for implementing a desired function can be reduced. As a result, the time required for developing the system having a desired function can be reduced.

### Second Embodiment

In a framework for establishing an application system according to a second embodiment, the system function is implemented by use of an embedded platform. Regarding substantially the same sections as the first embodiment, duplicated descriptions will hereinafter be omitted.

The framework explained in the first embodiment can operate on different hardware by a framework with a specific function such as a player, a recorder, or viewer, or by a module such as an IP module or a manager module.

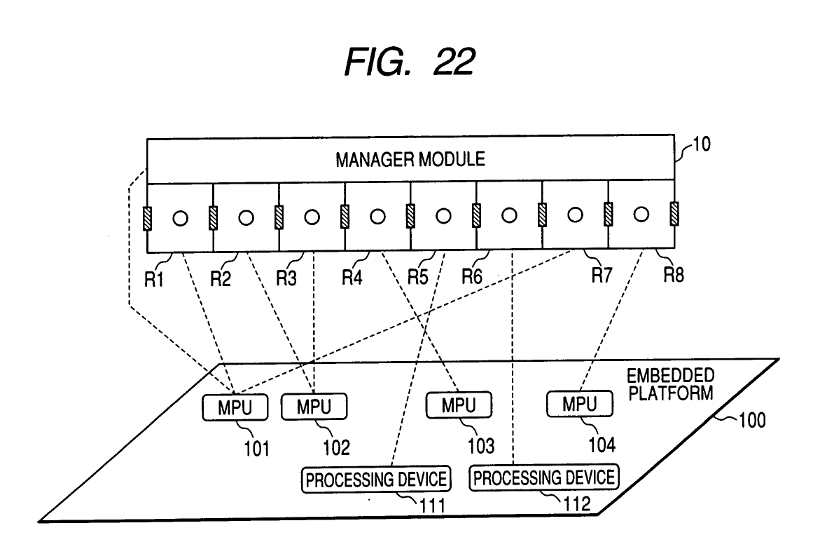

FIG. 22 shows an example in which a system function implemented by registering the IP modules M1-M8 respectively in the IP module areas R1-R8 of the manager module 10 operates on a plurality of kinks of hardware. The functions of the manager module and the IP modules M1 and M7 shown in FIG. 22 operate on the micro processing unit (MPU) 101. The functions of the IP modules M2 and M3 operate on the MPU 102. The function of the IP module M4 operates on the MPU 103. Further, the function of the IP module M8 operates on the MPU 104. The MPUs 101 through 104 can be formed on the same LSI, or respectively on a plurality of LSIs. Further, the functions of the IP modules M5 and M6 operate on processing devices 111 and 112, respectively. The processing devices 111 and 112 are, for example, an audio interface or an accelerator for video data. The MPUs 101 through 104 and the processing devices 111 and 112 are implemented on an embedded platform 100.

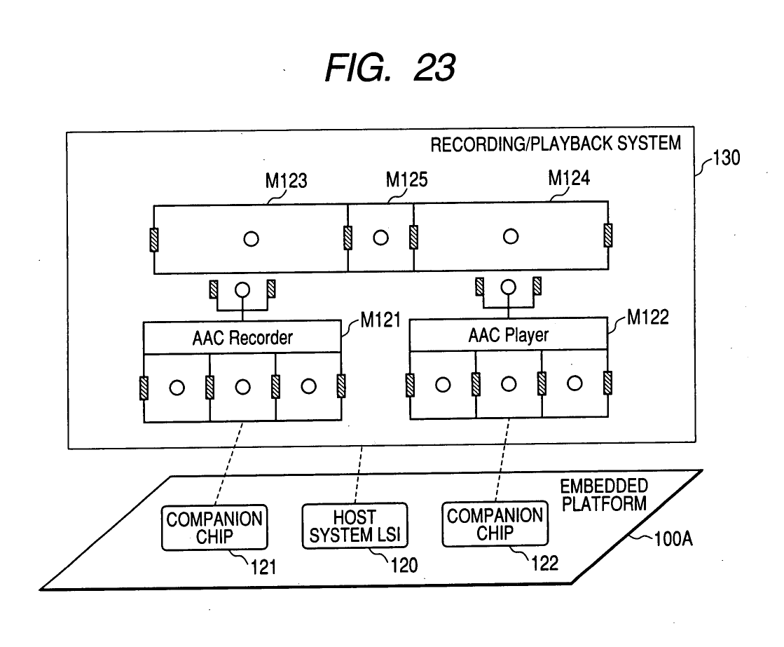

An example of implementing the system function by the embedded platform includes a host system LSI and two companion chips will hereinafter be explained. FIG. 23 shows an example of establishing a recording/playback system 130 in which an “AAC recording (AAC Recorder)” system operates on the companion chip 121 and an “AAC playback (AAC Player)” system operates on the companion chip 122. The “AAC recording” system is a recording system for the data compressed in the AAC format, and the “AAC playback” system is a playback system for the data compressed in the AAC format. The recording/playback system 130 operates on the host system LSI 120. The companion chips 121 and 122, and the host system LSI 120 are implemented on the embedded platform 10A.

The “AAC recording” system and the “AAC playback” system are respectively established on the companion chips 121 and 122 using the framework explained in the first embodiment. And, the IP module M121 is formed by encapsulating the core IP defined as the function of the “AAC recording” system and the command list including the configuration information and the processing content of the core IP represented as the class of the commands. Further, the IP module M122 is formed by encapsulating the core IP defined as the function of the “AAC playback” system and the command list including the configuration information and the processing content of the core IP represented as the class of the commands.

Further, the IP modules M123 and M124 for establishing communications between the “AAC recording” system and the host system LSI 120, and between the “AAC playback” system and the host system LSI 120, respectively, are formed.

The IP module M123 is formed by encapsulating the core IP defined as the driver establishing communication between the “AAC recording” system and the host system LSI 120 and the command list of the core IP. The IP module M124 is formed by encapsulating the core IP defined as the driver establishing communication between the “AAC playback” system and the host system LSI 120 and the command list of the core IP.

Further, when the data transfer between the “AAC recording” system and the “AAC playback” system is necessary, the IP module M125 for data transfer is created. And, the communication of information or data between the “AAC recording” system and the “AAC playback” system is created as a sequence pattern of the recording/playback system 130. And, by registering the IP modules M121 through M125 in the sequence pattern of the recording/playback system 130, the recording/playback system function is allowed to operate on the host system LSI 120.

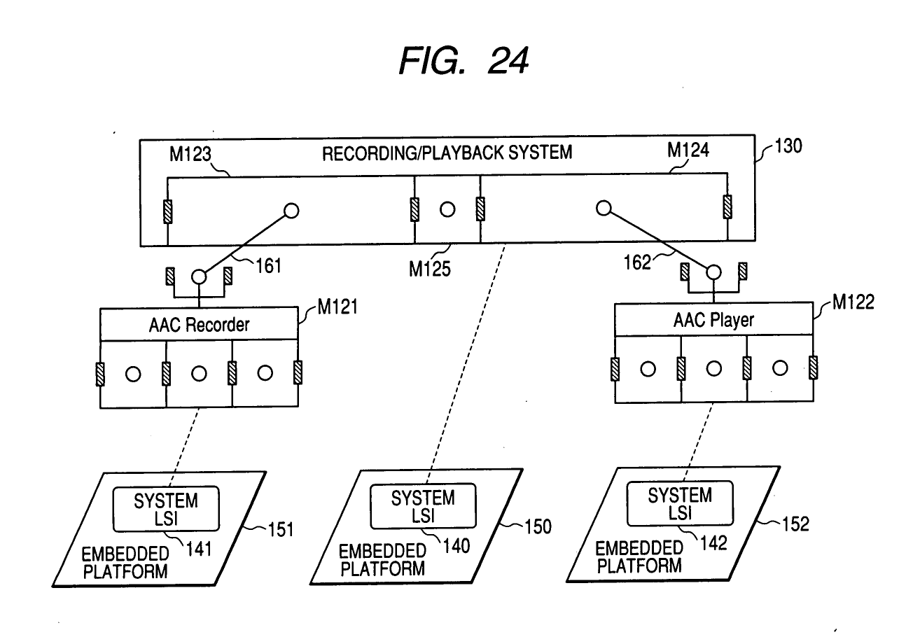

Note that it is also possible to implement the recording/playback system function explained above on three platforms. For example, as shown in FIG. 24, the IP module M121 is established on the system LSI 141, and the IP module M122 is established on the system LSI 142. Further, the IP modules M123 through M125 are established on the system LSI 140. The system LSIs 140-142 are respectively implemented on the embedded platforms 150 through 152. And, in a similar manner to the method described above, by modularizing communication means 161 between the system LSIs 140 and 141, and communication means 162 between the system LSIs 140 and 142 as the IP modules, the recording/playback system function can be implemented. Note here that the communication means is a peripheral component interconnect (PCI) bus, a network bus, or the like.

As explained above, according to the framework for establishing an application system relating to the second embodiment, the system function can be implemented on the hardware using the embedded platform. Namely, if the hardware available for establishing the IP module thereon is existing, the process of the core IP is implemented as hardware. As a result, the time required for developing the framework for implementing a desired system function can be reduced.

As described above and shown in FIGS. 23 and 24, IP modules (data processing modules) M121 and M122 includes a plurality of IP modules (data processing sub-modules) and a manager module (manager sub-module). The framework according to the second embodiment is capable of handling a plurality of IP modules (data processing sub-modules) and a manager module (manager sub-module) as a single IP module such as IP modules M121 and M122.

### Third Embodiment

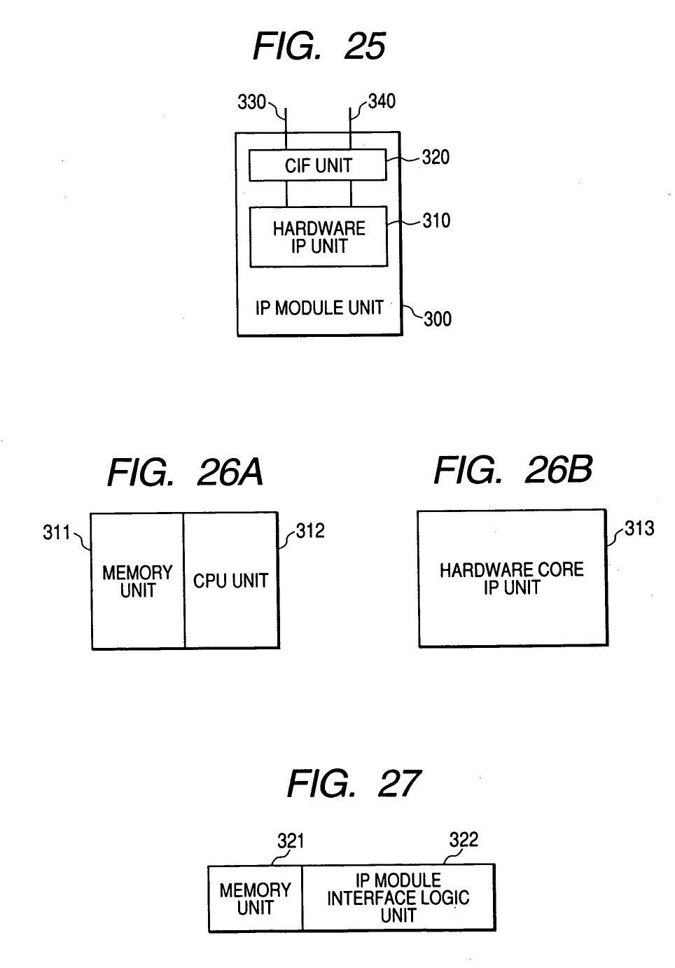

In the second embodiment, the case is explained, in which whether the core IP of each of the IP modules is implemented with software or with hardware is selected in consideration of implementation of a desired system function with existing hardware. A framework for establishing an application system according to a third embodiment is configured to be established by hardware in accordance with the configurations of the framework. Namely, by configuring a hardware unit most suitable for the manager module and the IP module of the framework, the framework of the desired system function is implemented as a semiconductor device (a framework hardware unit). The configuration of the framework hardware unit will hereinafter be explained with reference to FIGS. 25-31.

FIG. 25 shows the structure of the IP module unit 300 implements the IP module with hardware. As shown in FIG. 25, the IP module unit 300 includes a hardware IP unit 310 and a communication interface unit (hereinafter referred to as “CIF unit”) 320.

The hardware IP unit 310 implements the function of the core section 23 in the IP module with hardware. In the case in which the process in the core IP is implemented with the software control, the hardware IP unit 310 includes, as shown in FIG. 26A for example, a memory unit 311 and a CPU unit 312. The memory unit 311 stores a program for executing the process of the IP module unit 300 in a rewritable manner and a buffer used by the program. The CPU unit 312 executes the program for executing the process of the IP module unit 300. The memory unit 311 and the CPU unit 312 is selected in accordance with the conditions such as the performance required for the system, cost, or chip size. On the contrary, if the process in the core IP is performed on the hardware, the hardware IP unit 310 is configured as a hardware core IP unit 313 shown in FIG. 26B, for example. The hardware core IP unit 313 implements the IP module with hardware logic.

The CIF unit 320 implements the interface module 21 and the command list section 22 with hardware. As shown in FIG. 27, the CIF unit 320 includes a memory unit 321 and an IP module interface logic unit 322. The memory unit 321 stores command parameters in a rewritable condition. The IP module interface logic unit 322 implements the interface logic of the IP module with hardware.

Further, as shown in FIG. 25, the IP module unit 300 is equipped with a command line 330 for communicating commands with a hardware unit having the function of the manager module, and a data transfer line 340 for communicating data with the hardware unit.

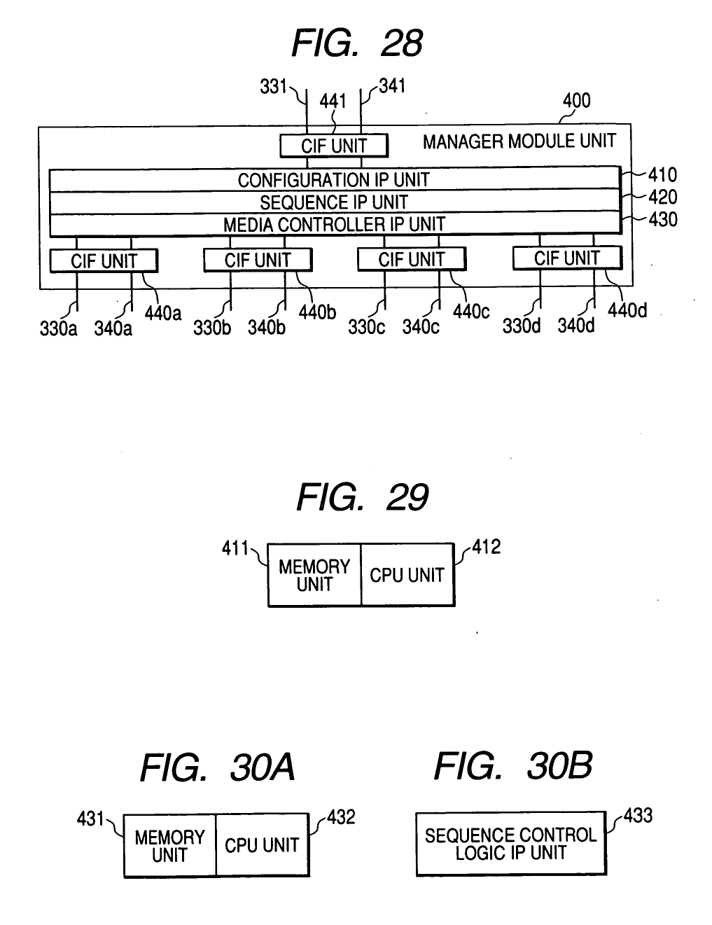

FIG. 28 shows an example of a manager module unit 400 implementing the manager module with hardware. As shown in FIG. 28, the manager module unit 400 includes a configuration IP unit 410, a sequence IP unit 420, a media controller IP unit 430, and the CIF units 440a-440d. The configuration IP unit 410 corresponds to the configuration module, and controls the sequence IP unit 420 and the media controller IP unit 430 to implement setting and interface function as the system. The configuration IP unit 410 includes a memory unit 411 and a CPU unit 412, for example as shown in FIG. 29. The sequence IP unit 420 corresponds to the sequence manager module, and is a hardware unit (sequence pattern logic unit) implementing the sequence pattern as a unit connection pattern. The media controller IP unit 430 is a control logic unit in accordance with the sequence pattern. In the case in which the logic is implemented with the software control, as shown in FIG. 30A, the media controller IP unit 430 includes a memory unit 431 and a CPU unit 432. In the case in which the logic is operated on the hardware, as shown in FIG. 30B, the media controller IP unit 430 is configured as a unit (sequence control logic IP unit) implementing the logic directly with the hardware. The CIF units 440a-440d have the same hardware configurations as the CIF unit 320 of the IP module unit 300 shown in FIG. 27.

As shown in FIG. 28, the manager module unit 400 is equipped with command lines 330a-330d for communicating commands with the IP module unit 300 and the data transfer lines 340a-340d for sending/receiving data. Although the example with four CIF units of 440a-440d is shown in FIG. 28, the number of the CIF units 440a-440d, command lines 330a-330d, and the data transfer lines 340a-340d can be set in accordance with the number of IP module units 300 connected to the manager module unit 400.

Further, the manager module unit 400 shown in FIG. 28 is equipped with a CIF unit 441, a command line 331 and a data transfer line 341. The CIF unit 441, the command line 331 and the data transfer line 341 are used, in the case in which the manager module unit 400 is used as the IP module unit, for communicating commands with and sending/receiving data to/from another manager module to which the manager module unit 400 is connected.

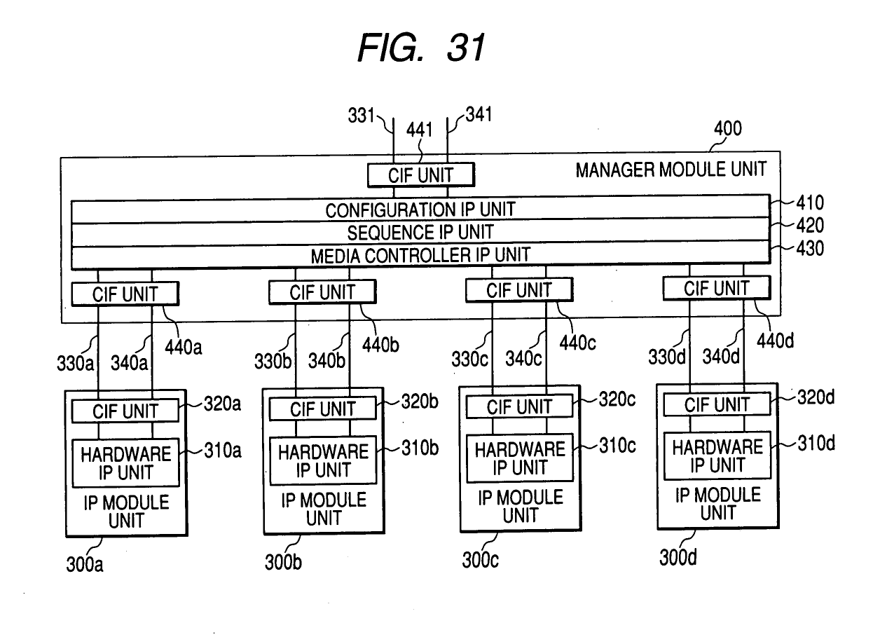

By embedding the framework including the IP module unit 300 shown in FIG. 25 and the manager module unit 400 shown in FIG. 28, the hardware unit implementing a desired system function can be configured. As an example, FIG. 31 shows an example of the hardware unit configured with the IP module units 300a-300d and the manager module unit 400. As shown in FIG. 31, the IP module units 300a-300d are connected to the manager module unit 400 via the command lines 330a-330d and the data transfer lines 340a-340d. The hardware unit thus configured can be implemented in the hardware such as a system LSI. Namely, a semiconductor device including the IP module units 300a-300d respectively having the CIF units 320a-320d, which are interfaces having the same functions, and the manager module unit 400 connected to the IP module units 300a-300d via the CIF units 320a-320d and for controlling data transfer between the IP module units 300a-300d and the processes in the IP module units 300a-300d can be realized.

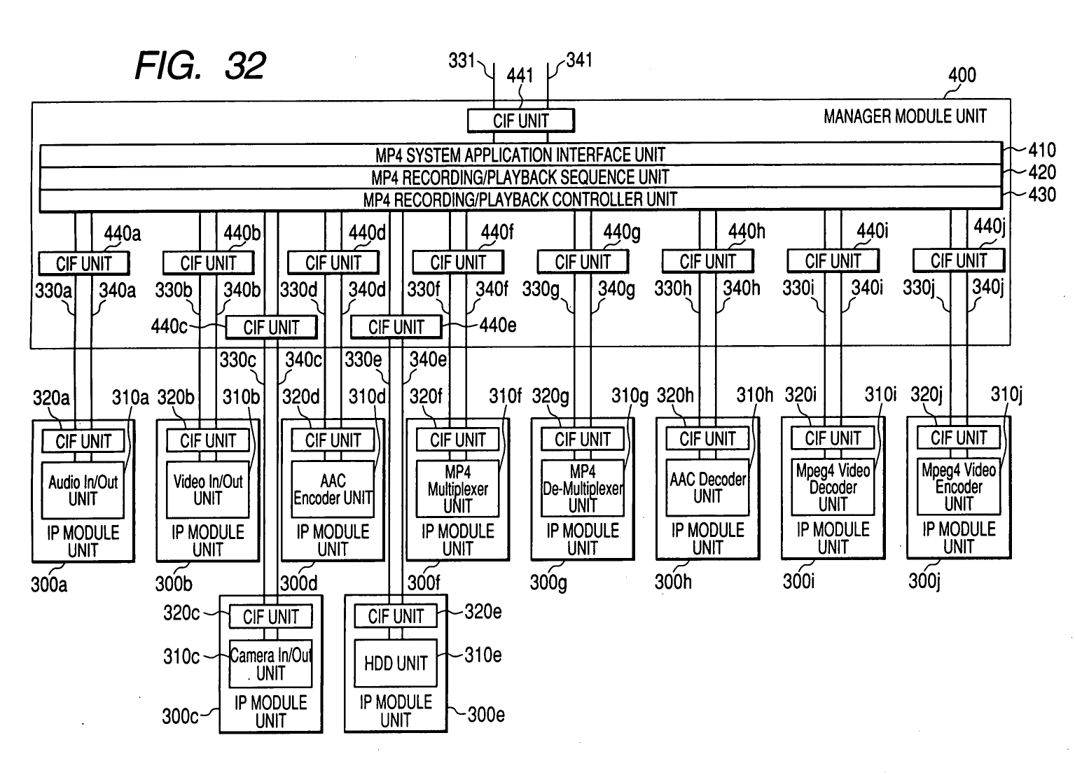

FIG. 32 shows an example of a framework hardware unit implementing with hardware the framework for realizing a recording/playback system of image and sound acquired by a digital camera and a microphone. The framework hardware unit shown in FIG. 32 realizes the MP4 recorder function and the MP4 player function. The MP4 recorder function is a function for compressing the audio data in the AAC format, and the video data in the MPEG4 format, and further storing them in the HDD as content multiplexed in the MP4 format. The MP4 player function is a function for demultiplexing and reproducing the content stored by the MP4 recorder function.

The manager module unit 400 shown in FIG. 32 has an MP4 system application interface unit as the configuration IP unit 410. Further, it has an MP4 recording/playback sequence unit and an MP4 recording/playback controller unit as the sequence IP unit 420 and the media controller IP unit 430, respectively. Further, the framework hardware unit shown in FIG. 32 has IP module units 300a-300j. The IP module units 300a-300j respectively have an “audio data input/output (Audio In/Out)” unit, a “video data input/output (Video In/Out)” unit, a “camera data input/output (Camera In/Out)” unit, an “AAC format data encoder (AAC Encoder)” unit, a “hard disk drive (HDD)” unit, an “MP4 data multiplexer (MP4 Multiplexer)” unit, an “MP4 data demultiplexer (MP4 De-Multiplexer)” unit, an “AAC format data decoder (AAC Decoder)” unit, an “MPEG4 video data decoder (MPEG4 Video Decoder)” unit, an “MPEG4 video encoder (MPEG4 Video Encoder)” unit, as the hardware IP units 310. The IP module units 300a-300j are connected to the manager module unit 400 via the command lines 330a through 330j and the data transfer lines 340a-340j, respectively.

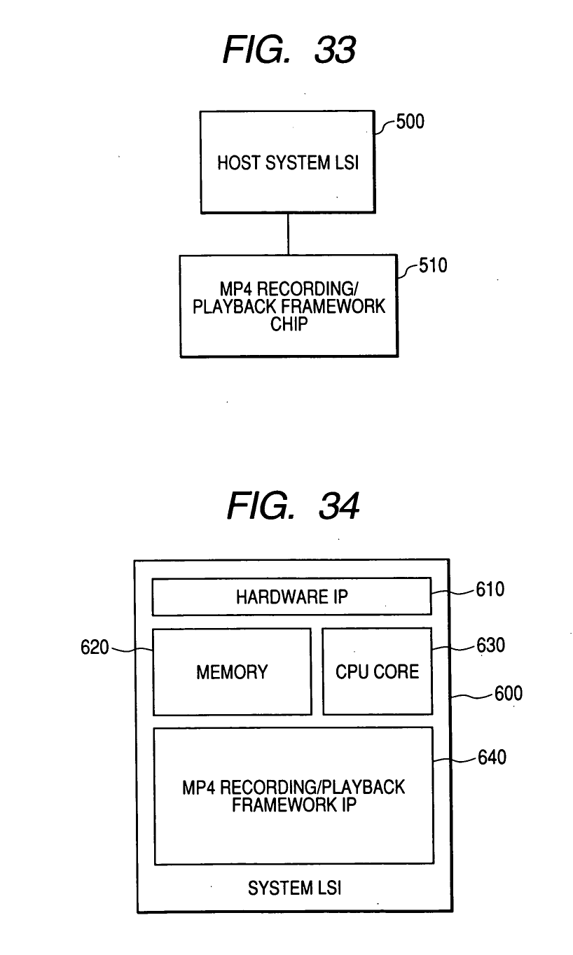

The system implemented with the framework hardware unit shown in FIG. 32 can be made hardware as the companion chip to form the MP4 recording/playback framework chip. For example, FIG. 33 shows an example in which the MP4 recording/playback framework chip 510 is connected to the host system LSI 500 where the final application system is established.

Further, the application system implemented with the framework hardware unit shown in FIG. 32 can be formed to be a single chip as an LSI integrally with the memory, the CPU, and other hardware on which the host system operates. For example, FIG. 34 shows an example in which the MP4 recording/playback framework chip 640 is implemented on the system LSI 600 together with the hardware IP 610, the memory 620, and the CPU core 630.

The semiconductor device according to the third embodiment is implemented as the framework hardware unit based on the manager module and the IP modules of the framework. Namely, it is a semiconductor device forming the framework for establishing an application system as hardware, which can reduce the time for developing a system implementing a desired function by controlling processes of a plurality of modules. Therefore, the framework having a desired system function can be implemented as the most suitable framework hardware unit, thus the desired system function can be processed with high speed.

As described with reference to the embodiments, there is provided a a framework for establishing an application system and a semiconductor device capable of reducing time required for recombination of modules for implementing a desired function can be provided.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A framework for establishing an application system, the framework comprising:
a plurality of data processing modules that is provided with an interface in common with one another, and performs data processing; and
a manager module that communicates with the data processing modules via the interface, and controls data transfer between the data processing modules and the data processing performed by each of the data processing modules.

2. The framework according to claim 1, wherein each of the data processing modules comprises:
a command list section that stores information that defines a behavior of the data processing; and
a core section that performs the data processing in the behavior defined by the information stored in the command list section.

3. The framework according to claim 2, wherein the command list section stores the information as a character string or as a numerical string.

4. The framework according to claim 2, wherein the core section includes a semiconductor integrated circuit including a processor that performs the data processing and a memory that provides a work area for the data processing.

5. The framework according to claim 2, wherein the manager module comprises:
a configuration manager module that manages the information stored in the command list section in each of the data processing modules;
a sequence manager module that generates a sequence list that defines an execution method for performing process including the data processing performed by the data processing modules; and
a media control module that controls the data processing performed by the data processing modules registered in the sequence list.

6. The framework according to claim 1, further comprising at least one semiconductor device that performs processes serving as the data processing modules and the manager module.

7. The framework according to claim 1, further comprising:
a first semiconductor device that performs a process serving as the manager module; and
at least one second semiconductor device that performs processes serving as the data processing modules.

8. The framework according to claim 7, wherein the first semiconductor device further performs a process serving as at least one of the data processing modules.

9. The framework according to claim 1, wherein at least one of the data processing modules comprises:
a plurality of data processing sub-modules that is provided with an interface in common with one another, and performs data processing; and
a manager sub-module that communicates with the data processing sub-modules via the interface, and controls data transfer between the data processing sub-modules and the data processing performed by each of the data processing sub-modules.
